(19) United States
(12) Patent Application Publication
(10) Pub. No.: US 2019/0053022 A1
(43) Pub. Date: Feb. 14, 2019

(54) PROVISION OF IN-VEHICLE SERVICE TO A MOBILE DEVICE

(71) Applicant: Intel Corporation, Santa Clara, CA (US)

(72) Inventor: Dibyendu CHATTERJEE, Bangalore (IN)

(21) Appl. No.: 15/855,194

(22) Filed: Dec. 27, 2017

(51) Int. Cl. H04W 4/50

(52) U.S. Cl. CPC H04W 4/50; H04W 4/48

(57) ABSTRACT

The present disclosure may be directed to servicing a mobile device within a vehicle having a plurality of generators at a plurality of locations within the vehicle to create a plurality of unique instances of electromagnetic signatures at the plurality of locations that may be used to identify where a mobile device is disposed in the vehicle and for an in-vehicle infotainment system to provide services to the location in which the mobile device is disposed.

### FIELD

Embodiments of the present disclosure generally relate to the field of computing within vehicles. More specifically, embodiments of the present disclosure relate to devices and methods for locating a mobile device.

### BACKGROUND

With the exponential growth of mobile devices, and in particular smart phone devices, it is more and more common for these mobile devices to be operated by passengers traveling in the vehicle, such as a car, van, or bus.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 shows a context diagram of a vehicle that includes a location identifier system coupled with an in-vehicle infotainment (IVI) system to identify the location of a mobile device within the vehicle and provide in-vehicle service to the mobile device, in accordance with various embodiments.

FIG. 2A-2B illustrate aspects of a conductive wire loop system producing a time-varying magnetic field that may be identified by a mobile device in proximity to the varying magnetic field, in accordance with various embodiments.

FIG. 3 illustrates an example interaction between the location identifier system, IVI, and multimedia components within a vehicle, in accordance with various embodiments.

FIG. 4 illustrates a block diagram of a mobile device, an IVI, and a location identifier system, in accordance with various embodiments.

FIG. 5 illustrates an example process for implementing a location identifier system, in accordance with various embodiments.

FIG. 6 illustrates an example process for implementing a mobile device, in accordance with various embodiments.

FIG. 7 illustrates an example process for implementing an IVI, in accordance with various embodiments.

FIG. 8 illustrates an example computing device suitable for use to practice aspects of the present disclosure, in accordance with various embodiments.

FIG. 9 illustrates an example non-transitory computer-readable storage medium having instructions configured to practice all or selected ones of the operations associated with the processes described herein.

### DETAILED DESCRIPTION

This disclosure may include systems, processes, and apparatuses for locating one or more mobile devices within a vehicle, and providing in-vehicle service to the mobile device. The vehicle may include an apparatus for servicing a mobile device within the vehicle that includes a plurality of generators at a plurality of locations within the vehicle to respectively generate a plurality of electromagnetic signatures at the plurality of locations. The apparatus may also include a control logic block coupled to the plurality of generators to cause the plurality of generators to respectively generate unique instances of the plurality of electromagnetic signatures at the plurality of locations. At least one of unique instance of the plurality of electromagnetic signatures may be sensed and reported by a mobile device to an in-vehicle infotainment (IVI) system of the vehicle. The IVI system may identify the mobile device as being disposed in one of the plurality of locations based at least in part on the reporting, and then the IVI system provides services to the location the mobile device is disposed. In embodiments, the unique instances of the electromagnetic signatures are different time-varying magnetic fields.

In embodiments, the vehicle may include one or more conductive wire loops that may be located in one or more places within a vehicle. In particular, the one or more conductive wire loops may be positioned under one or more seating locations within the vehicle. In embodiments, to determine a location of a mobile device within the vehicle, a different pattern of time-varying current may be sent through each conductive wire loop within the vehicle. A particular pattern of time-varying current may create a similar pattern of time-varying magnetic field respectively at each of the one or more seating locations. A device, in particular a mobile device such as a smart phone that may be at or near one of the seating locations, may identify the pattern of the time-varying magnetic field and report an identification of that pattern to a system to determine a seating location within the vehicle. In embodiments, a person seated at a particular seating location within the vehicle may have a smart phone that includes a Hall Effect sensor that may identify a pattern of the time-varying magnetic field.

The mobile device may then report the identified pattern of the time-varying magnetic field to an in-vehicle system that may map each identified pattern of time-varying magnetic fields with a respective seating location within the vehicle. In embodiments, the mobile device may communicate with the in-vehicle system using Bluetooth®, Wi-Fi, cellular or other communication technology. In embodiments, the in-vehicle system may include an IVI system or other system. Using this mobile device location technique, the location of a mobile device used by a passenger within the vehicle may be identified, which may allow the IVI or other in-vehicle system to provide a customized experience using the multimedia devices proximate to the passenger when interacting with the mobile device.

An IVI system may include managing and playing audio content, utilizing navigation for driving, delivering rear-seat entertainment such as movies, games, social networking, etc., listening to incoming and sending outgoing SMS text messages, making phone calls, and accessing Internet-enabled or smartphone-enabled content such as traffic conditions, sports scores and weather forecasts. In embodiments, each mobile device within the vehicle may be connected to the IVI system.

In embodiments, if a phone call comes in for a particular mobile device, the IVI system may be aware that a mobile device within the vehicle is receiving a phone call. The IVI system may then determine at what seating location within the vehicle the mobile device is located. Once the seating location of the mobile device is determined, then the in-vehicle multimedia devices proximate to that seating location may be used to augment the interaction the passenger has with the mobile device. For example, a display, dashboard, heads up display, instrument cluster, audio speakers within audio zones, rear seat entertainment (RSC) systems, and the like may interact with the passenger at that seating location. In embodiments, if one passenger handed a mobile device to another passenger at a different seat, the IVI system would update the location of the mobile device using the techniques described herein, and the in-vehicle multimedia devices local to the new passenger seating location may be used.

Other examples, notification of an incoming phone call to a smart phone within the vehicle may be displayed on a video display in front of the passenger whose phone is ringing. A passenger may play music or watch a video from the passenger's phone and have the audio played over speakers in the passenger's audio zone or displayed on the passenger's video display. If a passenger wants to show a second passenger a photo or video clip playing on a mobile device, the passenger may hand the mobile device to the second passenger and have the photo or video clip displayed on the multimedia devices for the second passenger's zone. If a passenger seen changes seats within the vehicle, then any audio, video, or other multimedia interaction the passenger has with the mobile device will move to the in-vehicle multimedia devices within the passenger's new seating location.

In the following description, various aspects of the illustrative implementations are described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

The term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The term “computer-readable storage media” may refer to, be a part of, or otherwise include media on which data, including instructions of a module that may be executed, may reside. Computer-readable storage media may be either transitory, or non-transitory.

As used herein, the term semi-autonomous driving is synonymous with computer-assisted driving. The term does not mean exactly 50% of the driving functions are automated. The percentage of driving functions automated may be a fraction of a percent to almost 100%.

Various operations may be described herein as multiple discrete operations in turn, in a manner that is most helpful in understanding the claimed subject matter. However, the order of description should not be construed as to imply that these operations are necessarily order dependent.

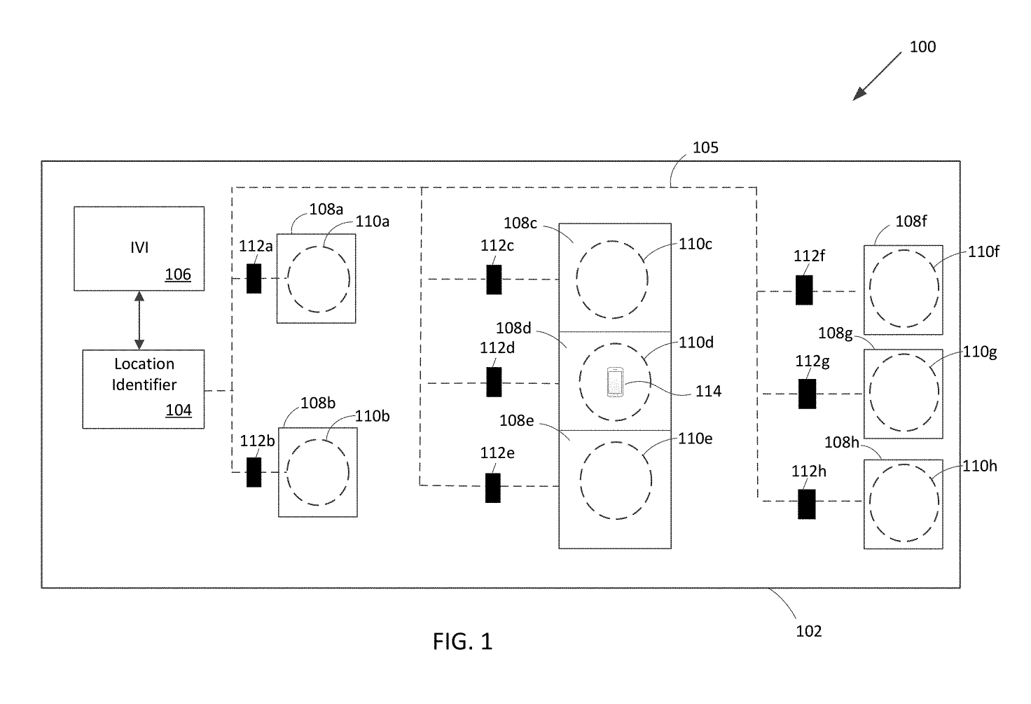

FIG. 1 shows a context diagram of a vehicle that includes a location identifier system coupled with an in-vehicle infotainment (IVI) system to identify the location of a mobile device within the vehicle, and provide in-vehicle service to the mobile device, in accordance with various embodiments. Diagram 100 shows a scenario of a vehicle 102, which may also be a computer assisted/automated driving (CA/AD) vehicle. Vehicle 102 may include a location identifier system 104 and an IVI system 106. Within the vehicle 102 there may be multiple passenger locations 108a-108h.

The location identifier system 104 may be electrically coupled by an electrically conductive wire 105 to one or more conductive wire loops 110a-110h, or one or more signal modulators 112a-112h. The signal modulators 112a-112h, in response to commands of location identifier 104, may respectively modulate different patterns of time-varying current to flow through each of the conductive wire loops 110a-110h. As a result of this time-varying current flow, different patterns of time-varying magnetic fields may be generated that are proximate to each of the conductive wire loops 110a-110h. Together, the one or more signal modulators 112a-112h respectively in combination with the conductive wire loops 110a-110h may be referred to as one or more magnetic field generators.

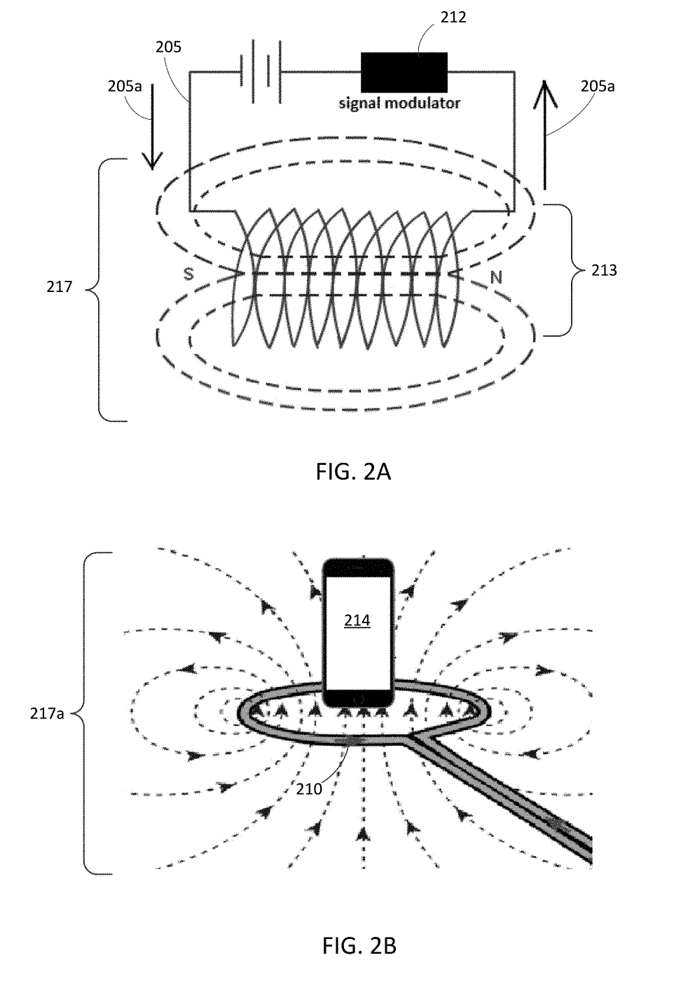

A mobile device 114, which in embodiments may be a smart phone that includes a function to detect and identify different patterns of a time-varying magnetic field may identify a particular pattern of a time-varying magnetic field. This time-varying magnetic field identification may then be reported, for example to an IVI system 106 or some other system, which in turn, may be used to determine the device's location within the vehicle 102, e.g., a seating location proximate to one of the conductive wire loops 110a-110h. This is discussed further with respect to FIGS. 2A-2B.

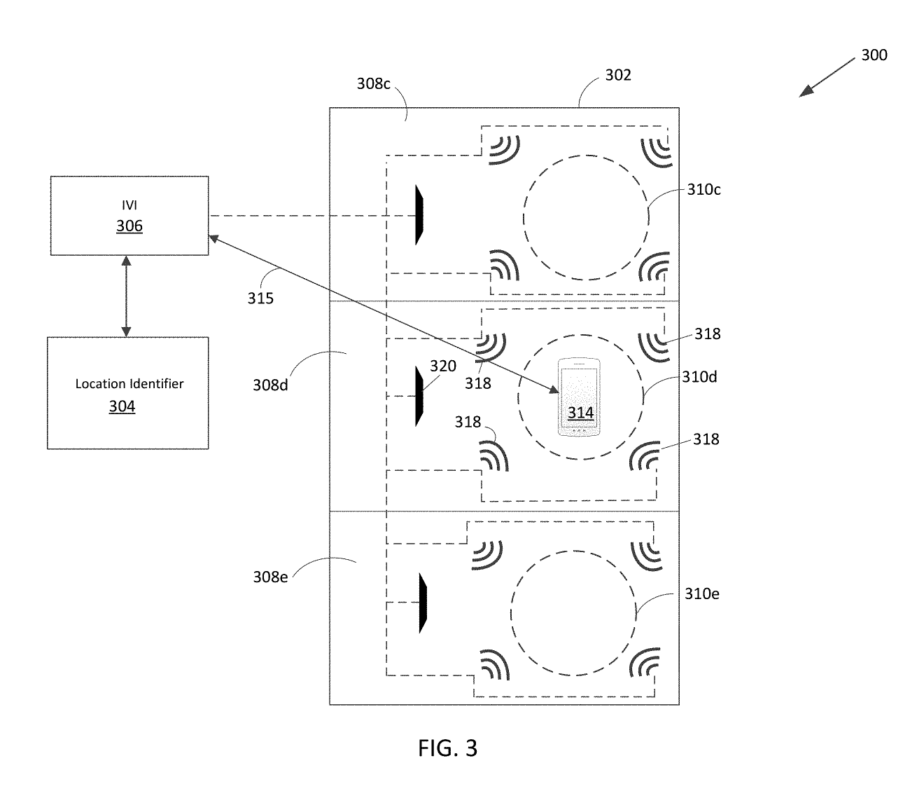

The IVI system 106 may be coupled to and use the location identifier system 104 to facilitate identifying the location of a mobile device 114 within the vehicle 102. For example, mobile device 114 may be at passenger location 108d, and may connect with the IVI system 106 via Bluetooth or other wireless connectivity technology. In embodiments, the IVI system 106 may request the location identifier 104 to cause the time-varying magnetic fields to be generated for the mobile device 114. On receipt of the reporting of the time-varying magnetic field identification by the mobile device 114, the IVI system 106 may identify the location of the mobile device 114. Further, the IVI system 106 may use the location of mobile device 114 to provide in-vehicle multimedia devices tailored to a passenger location 108d to enhance the mobile device 114 user experience. This is discussed further with respect to FIG. 3.

FIGS. 2A-2B illustrate aspects of a conductive wire loop system producing a time-varying the magnetic field that may be identified by a mobile device in proximity to the varying magnetic field, in accordance with various embodiments. FIG. 2A shows a flow of current 205a down a wire 205, which may be similar to wire 105 of FIG. 1, from a signal modulator 212, which may be similar to one of signal modulators 112a-112h of FIG. 1 to a conductive wire loop 213. The electric field 217 may result from the current 205a flowing through the conductive wire loop 213. In embodiments, the signal modulator 212 may cause the current 205a to flow in a specific time-varying pattern. Because a magnetic field (flux) and current through a conductive wire loop may be directly proportional, a time-varying pattern in current may generate a similar time-varying pattern in the magnetic field 217.

FIG. 2B shows a conductive wire loop 210, that may be similar to conductive wire loop 213 or to one of conductive wire loop 110a-110h of FIG. 1, that may be generating a time-varying magnetic field 217a, that may be similar to the time-varying magnetic field 217. A mobile device 214, which may be similar to mobile device 114 of FIG. 1, may be placed within the magnetic field 217a. The mobile device 214 may include a Hall Effect sensor to detect or identify the time-varying pattern in the magnetic field 217a. In embodiments, the mobile device 214 may decode the pattern and send an indication of the decoding to the IVI 106 of FIG. 1 for identification of the seating location of the conductive wire loop 210 within the vehicle 102.

In embodiments, because the magnetic field 217a is directional, inside the conductive wire loop 210 the direction of the magnetic lines may be opposite to the direction outside of the conductive wire loop 210. If the Hall Effect sensor identifies when the magnetic field becomes inverted, the sensor may then identify that it is out of the loop. This may also provide for very high precision location identification because there are well-defined boundaries to the location areas, such as passenger locations 108a-108h of FIG. 1.

FIG. 3 illustrates an example interaction between the location identifier system, IVI, and multimedia components within a vehicle, in accordance with various embodiments. Diagram 300 shows a portion of a vehicle 302, which may be similar to vehicle 102 of FIG. 1 that includes three passenger locations 308c-308e, which may be similar to 108c-108e of FIG. 1, that respectively include conductive wire loops 310c-310e, which may be similar to conductive wire loops 110c-110e of FIG. 1. A mobile device 314, which may be similar to mobile device 114 of FIG. 1, may be placed proximate to the conductive wire loop 310d, for example by being held by a vehicle 302 passenger (not shown).

In embodiments, the mobile device 314 may connect with the IVI system 306, which may be similar to IVI system 106 of FIG. 1, to register itself with the IVI system 306. In embodiments, the connection for this registration may be made via a Bluetooth connection 315 or by some other wireless connection. In embodiments, once connected, the mobile device 314 may communicate with the IVI system 306, for example, to share data based on the applications running on the mobile device 314.

The IVI system 306 may control various in-vehicle devices within the vehicle 302, which may include, multimedia components associated with each respective passenger locations 308c-308e. Multimedia components may include speakers 318 or a video display 320. Other components may include haptic devices (not shown) to vibrate seats, temperature adjustment devices (not shown) to raise or lower the temperature of the seats, or climate control (not shown) to control airflow and temperature for individual passenger locations 308c-308e.

Once the mobile device 314 is registered with the IVI system 306, activity on the mobile device 314 may be monitored by the IVI system 306 to determine whether that activity may be enhanced by one or more devices within the vehicle. In embodiments, after the location of the mobile device 314 is determined within the vehicle 302 using the location identifier 304 (which may be location identifier 104 of FIG. 1) described herein, the IVI system 306 may use those devices at the passenger location (e.g. passenger location 308d) to provide services to the mobile device 314. For example, and incoming phone call that is accepted by mobile device 314 may have the audio of the phone call played over speakers 318. In another example, a streaming video playing on mobile device 314 may have the video portion routed to display 320 and the audio portion played on in-vehicle speakers 318.

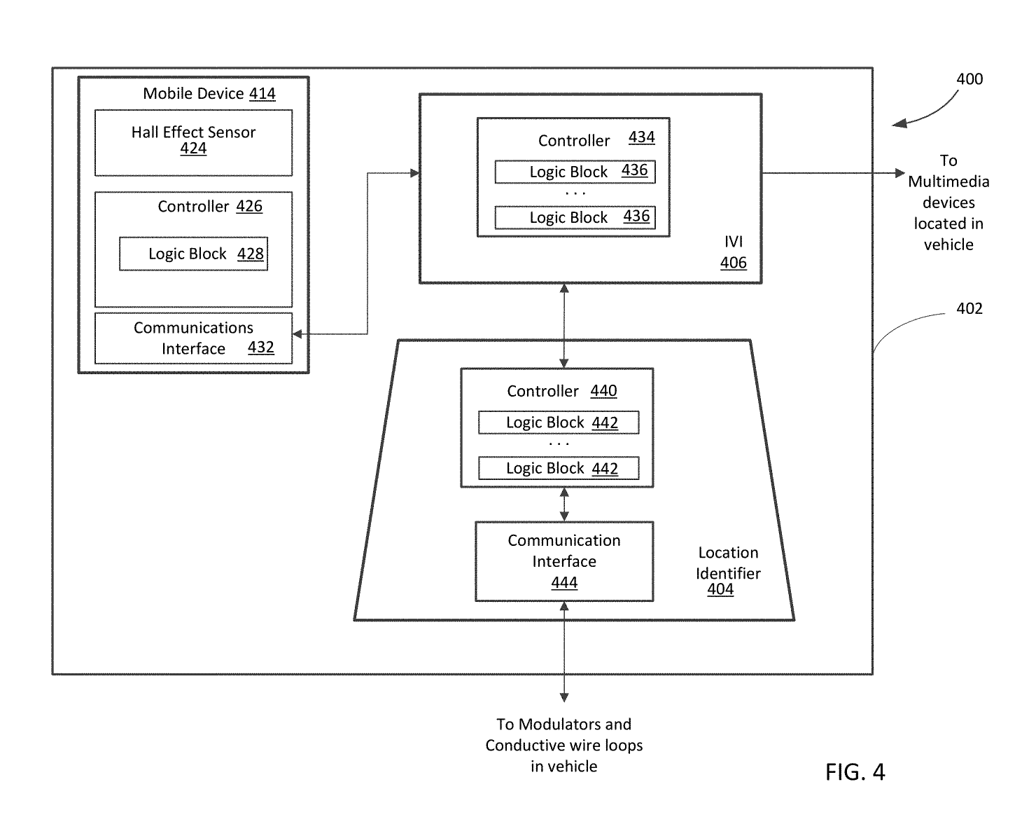

FIG. 4 illustrates a block diagram of a mobile device, an IVI, and a location identifier system, in accordance with various embodiments. Diagram 400 shows a mobile device 414, which may be similar to mobile device 314 of FIG. 3, an IVI 404, which may be similar to IVI 104 of FIG. 1, and a location identifier 404 system, which may be similar to the location identifier 104 system of FIG. 1.

The mobile device 414 may include a Hall Effect sensor 424, as described above, that may be used to detect a pattern of time-varying magnetic fields when it is proximate to a conductive wire loop, such as conductive wire loop 110a-110h of FIG. 1. The mobile device 414 may also include a controller 426 that may include one or more logic blocks 428. In embodiments, the logic blocks 428 may identify the time-varying magnetic field detected, identify a code associated with the time-varying magnetic field detected, or other similar processes. The mobile device 414 may also include a communications interface 432, that may be used, for example, to communicate instructions or data with the IVI 404.

The IVI 404 may include a controller 434 and one or more logic blocks 436. In embodiments, the logic blocks may receive an indication of an audiovisual event on a mobile device 414, identify a location of the mobile device 414 within a vehicle 402, identify in-vehicle audio or video devices proximate to the identified location of the mobile device 414, present audio or video associated with the audiovisual event on the audio or video device is proximate to the identified location of the mobile device 414, or to receive one or more commands from the mobile device 414 to control the in-vehicle audio or video devices proximate to the identified location of the mobile device 414.

The location identifier 404 may include a controller 440 that may include one or more logic blocks 442. In embodiments, the logic blocks 442 may cause one or more time-varying currents to flow, respectively, through one or more conductive wire loops 110a-110h at a time-varying pattern, at one or more seating locations within a vehicle. The result of the current flow may be to generate one or more time-varying magnetic fields that may be used to identify, respectively, the one or more seating locations 110a-110h in the vehicle 102. The logic blocks 442 may also receive a command from an IVI 404 system to cause the time-varying currents to be sent. The location identifier 404 may also include a communications interface 444 that may be used to communicate instructions or data with the IVI 404.

In embodiments, each of controllers 426, 434 and 440 may be implemented in hardware, software or combination thereof. Hardware implementations may include ASIC, programmable circuits, such as FPGA. Software implementations may include instructions executable by one or more processor and memory arrangements.

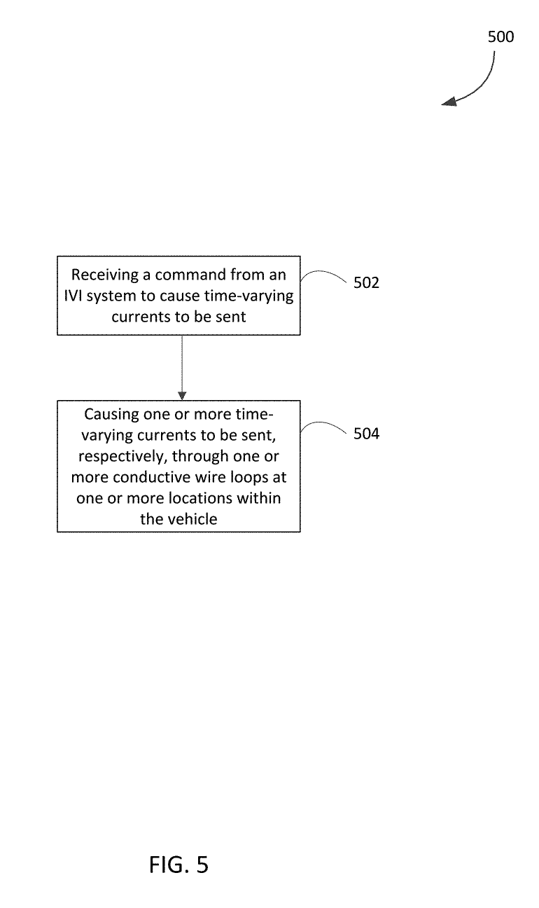

FIG. 5 illustrates an example process for implementing a location identifier system, in accordance with various embodiments. The process 500 may be performed, for example, by the location identifier 104 of FIG. 1, location identifier 304 of FIG. 3, location identifier 404, the controller 440 including logic blocks 442 of FIG. 4, or by a system 800 (e.g., computing device) configured to implement a location identifier system, as described in reference to FIGS. 1-4.

The process may begin at block 502, and may include receiving a command from an IVI system to cause time-varying magnetic fields to be generated at various locations of the vehicle. In embodiments, the IVI system may include IVI 106 of FIG. 1, IVI 306 of FIG. 3, or IVI 406 of FIG. 4. In embodiments, another system that may be communicatively coupled with the IVI system 106 may provide the command or an indication of a command.

At block 504, the process may include commanding one or more signal modulators to modulate one or more time-varying currents to flow, respectively, through one or more conductive wire loops at one or more locations within the vehicle. In embodiments, the one or more signal modulators may be signal modulators 112a-112h. In embodiments, the conductive wire loops may be the conductive loops 110a-110h of FIG. 1, conductive loop 210 of FIG. 2B, or conductive loops 310c-310e of FIG. 3. The conductive loops may include a signal modulator such as signal modulator 212 of FIG. 2A that may cause different patterns of time-varying currents to be sent through the conductive wire loop. As a result, different patterns of a time-varying magnetic field may result, such as magnetic field 271a of FIG. 2B. A Hall Effect sensor within a mobile device, such as mobile device 214, may sense and identify the specific pattern of a particular time-varying magnetic field. In embodiments, the different patterns may be associated respectively with different passenger seating location such as passenger locations 110a-110h of vehicle 102 as shown in FIG. 1.

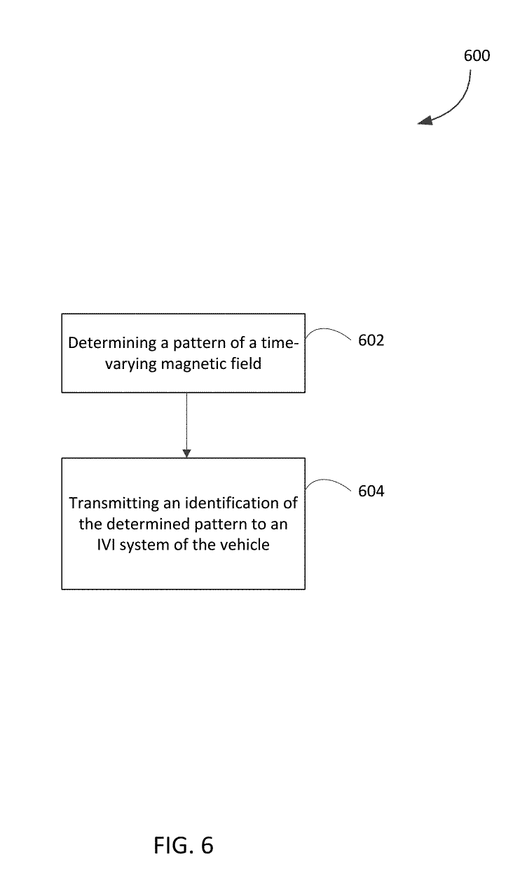

FIG. 6 illustrates an example process for implementing a mobile device, in accordance with various embodiments. The process 600 may be performed, for example, by mobile device 114 of FIG. 1, mobile device 214 of FIG. 2B, mobile device 314 of FIG. 3, mobile device 414 of FIG. 4, or by a system 800 (e.g., computing device) configured to implement a mobile device, as described in reference to FIGS. 1-4.

The process may begin at block 602, and may include determining a pattern of a time-varying magnetic field. In embodiments, the mobile device 114 may include a Hall Effect sensor 424 or some other magnetic field detection sensor that may detect a magnetic field and determine its time-varying pattern. In embodiments, this time-varying magnetic field may be generated by current following through conductive loops 110a-110h respectively modulated by signal modulators 112a-112h at locations within a vehicle 102.

At block 604, the process may include transmitting an identification of the determined pattern to an IVI system of the vehicle. In embodiments, the determined pattern of the time-varying magnetic field may correspond to a code or to some other identifier associated with a passenger location 108a-108h within vehicle 102. In embodiments, the mobile device 414 may identify the pattern and the location within the vehicle 102 with which the pattern is associated, and may transmit that location to the IVI 404. In embodiments, the mobile device 414 may transmit an indication of the pattern to the IVI 404 for decoding and association with a location within the vehicle 102.

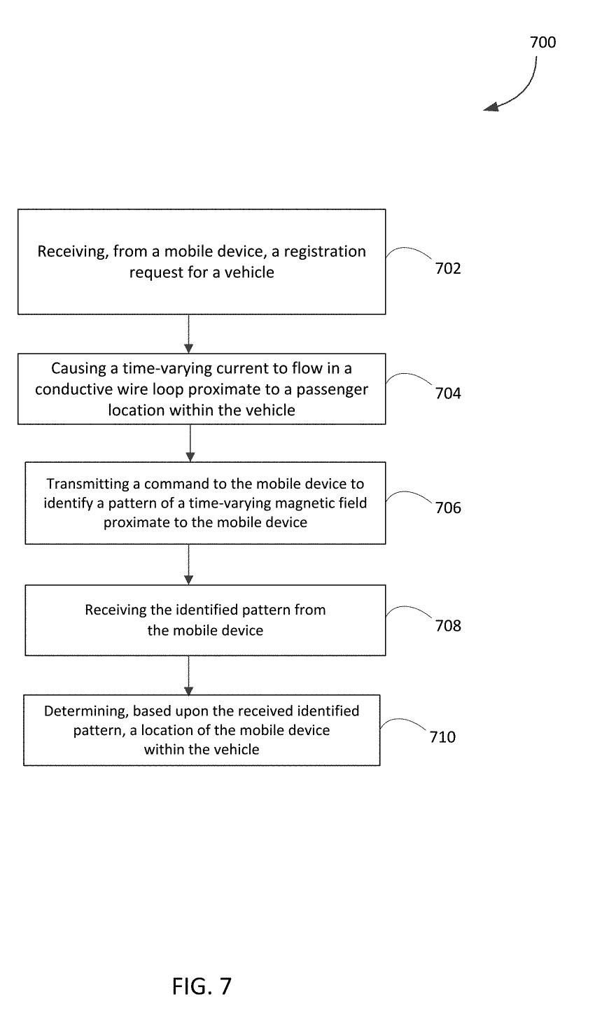

FIG. 7 illustrates an example process for implementing an IVI, in accordance with various embodiments. The process 700 may be performed, for example, by IVI 106 of FIG. 1, IVI 306 of FIG. 3, IVI 404 of FIG. 4, or by a system 800 (e.g., computing device) configured to implement an IVI, as described in reference to FIGS. 1-4.

The process may begin at block 702, and may include receiving, from a mobile device, a registration request for a vehicle. In embodiments, the IVI 106 associated with vehicle 102 may receive a request from a mobile device 114, which may be a smart phone, to register with the IVI 106. After registration, the IVI 106 and mobile device 114 may communicate data with each other. The registration, as well as the data communication, may occur over a Bluetooth, Wi-FI, or other communications mechanism.

At block 704, the process may include causing a location identifier to cause time-varying magnetic fields be generated proximate to the passenger locations with the vehicle. In embodiments, the IVI 106 may send one or more commands to the location identifier 104 module to cause the time-varying magnetic fields be generated at each passenger location 110a-110h. In embodiments, signal modulators 112a-112h may respectively be caused to modulate time-varying currents onto various conductive wire loops 110a-110h to generate the different patterns of time-varying magnetic fields at each passenger location 108a-108h that, when identified, may located each of the different locations within the vehicle 102.

At block 706, the process may include transmitting a command to the mobile device to identify a pattern of a time-varying magnetic field proximate to the mobile device. As described elsewhere herein, the mobile device may include a Hall Effect sensor 424 that may detect a pattern of a varying magnetic field.

At block 708, the process may include receiving the identified pattern from the mobile device. In embodiments, the mobile device 114 may transmit an identification of the pattern, to the IVI 106.

At block 710, the process may include determining, based upon the received identified pattern, the location of the mobile device within the vehicle. In embodiments, the identified pattern may be associated with one of a plurality of seating locations 108a-108h. In embodiments, once the IVI 106 has determined at which seating location the mobile device 114 is at, then the IVI 106 may integrate one or more multimedia functions 318, 320 within the vehicle 302 that are proximate to the mobile device 314 to augment the user interaction mobile device 314.

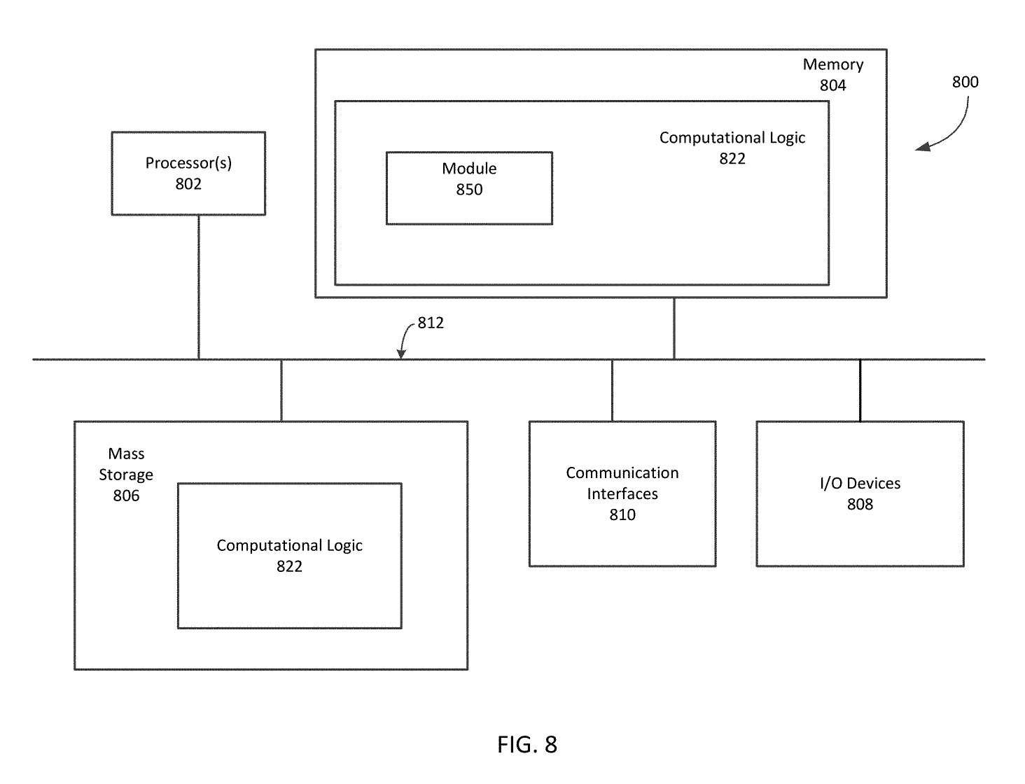

FIG. 8 illustrates an example computing device suitable for use to practice aspects of the present disclosure, in accordance with various embodiments. For example, the example computing device 800 may be suitable to implement the functionalities associated with diagrams 100, 200, 300, and/or 400, 500.

As shown, computing device 800 may include one or more processors 802, each having one or more processor cores, and system memory 804. The processor 802 may include any type of unicore or multi-core processors. Each processor core may include a central processing unit (CPU), and one or more level of caches. The processor 802 may be implemented as an integrated circuit. The computing device 800 may include mass storage devices 806 (such as diskette, hard drive, volatile memory (e.g., dynamic random access memory (DRAM)), compact disc read only memory (CD-ROM), digital versatile disk (DVD) and so forth). In general, system memory 804 and/or mass storage devices 806 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 800 may further include input/output (I/O) devices 808 such as a display, keyboard, cursor control, remote control, gaming controller, image capture device, or one or more in-vehicle devices such as speakers, video displays, touch displays, heads-up displays, and so forth, and communication interfaces 810 (such as network interface cards, modems, infrared receivers, radio receivers (e.g., Bluetooth), and so forth). I/O devices 808 may be suitable for communicative connections with in-vehicle devices, mobile devices, conductive wire loops, and the like. In some embodiments, I/O devices 808 when used as user devices may include a device necessary for establishing communications between an IVI and mobile device, as may be described in relation to FIGS. 1-4.

The communication interfaces 810 may include communication chips (not shown) that may be configured to operate the device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 810 may operate in accordance with other wireless protocols in other embodiments. The communication interfaces 810 may implement one or more features of communications interface 432 and communication interface 444 of FIG. 4.

The above-described computing device 800 elements may be coupled to each other via system bus 812, which may represent one or more buses. In the case of multiple buses, they may be bridged by one or more bus bridges (not shown). Each of these elements may perform its conventional functions known in the art. In particular, system memory 804 and mass storage devices 806 may be employed to store a working copy and a permanent copy of the programming instructions implementing the operations and functionalities associated with some of the components of diagrams 100, 200, 300, and/or 400, such as controller 426, controller 434, controller 440 and so forth, generally shown as computational logic 822. Computational logic 822 may be implemented by assembler instructions supported by processor(s) 802 or high-level languages that may be compiled into such instructions.

System memory 804 and/or mass storage devices 806, may also include data such as data associating different time-varying magnetic fields respectively to various seating locations 108a-108h of FIG. 1.

The computational logic 822 may contain one or more modules 850, which may perform one or more functions associated with FIGS. 1, 2A, 2B, 3, 4, 5, 6, or 7 or diagrams 100, 300, 400, 500, 600, 700. In embodiments, when implementing a mobile device 414, module 850 may include a controller module, which may perform one or more of the functions associated with controller 425 of FIG. 4, or associated with process 600 of FIG. 6. In embodiments, when implementing an IVI 404, module 850 may include a controller module, which may perform one or more of the functions associated with controller 434 of FIG. 4, or associated with process 700 of FIG. 7. In embodiments, when implementing a location identifier 404, module 850 may include a controller module, which may perform one or more of the functions associated with controller 440 of FIG. 4 or associated with process 500 of FIG. 5.

The permanent copy of the programming instructions may be placed into mass storage devices 806 in the factory, or in the field, though, for example, a distribution medium (not shown), such as a compact disc (CD), or through communication interfaces 810 (from a distribution server (not shown)).

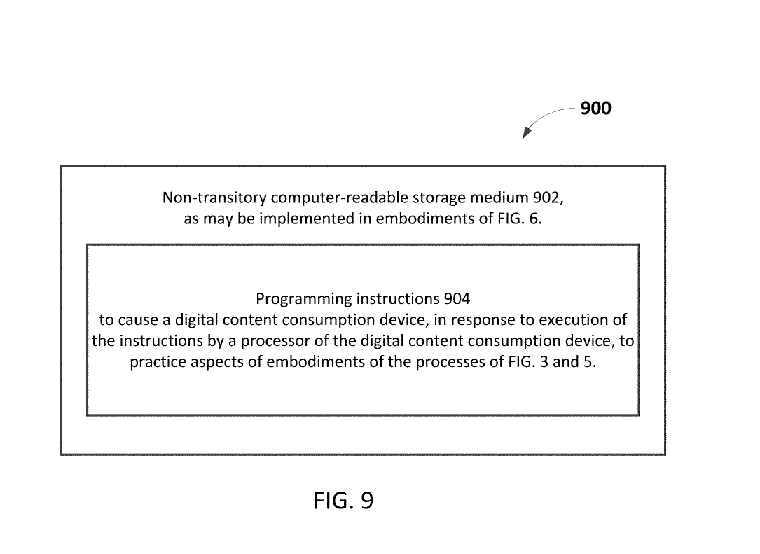

FIG. 9 illustrates an example non-transitory computer-readable storage medium having instructions configured to practice all or selected ones of the operations associated with the processes described herein. As illustrated, non-transitory computer-readable storage medium 902 may include a number of programming instructions 904 (e.g., including a controller module and logic blocks). Programming instructions 904 may be configured to enable a device, e.g. computing device 800, in response to execution of the programming instructions, to perform one or more operations of the processes described in reference to FIGS. 1-5. In alternate embodiments, programming instructions 904 may be disposed on multiple non-transitory computer-readable storage media 902 instead. In still other embodiments, programming instructions 904 may be encoded in transitory computer-readable signals.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

### EXAMPLES

Examples, according to various embodiments, may include the following.

Example 1 may be an apparatus for servicing a mobile device within a vehicle, comprising: a plurality of generators disposed at a plurality of locations within the vehicle to respectively generate a plurality of electromagnetic signatures at the plurality of locations; and a control logic block coupled to the plurality of generators to cause the plurality of generators to respectively generate unique instances of the plurality of electromagnetic signatures at the plurality of locations; wherein at least one of unique instance of the plurality of electromagnetic signatures is sensed and reported by a mobile device to an in-vehicle infotainment (IVI) system of the vehicle; wherein the IVI system identifies the mobile device as being disposed in one of the plurality of locations based at least in part on the reporting; and wherein the IVI system provides services to the location the mobile device is disposed.

Example 2 may include the apparatus of example 1, wherein the unique instances of the electromagnetic signatures are different time-varying magnetic fields.

Example 3 may include the apparatus of example 2, wherein each of at least two of the plurality of generators comprises a signal modulator and a conductive wire loop, and wherein the control logic block causes the two signal modulators to respectively modulate two different time-varying currents on the two conductive wire loops to cause generation of two of the different time-varying magnetic fields.

Example 4 may include the apparatus of example 3, further comprising a communication interface coupled with at least the two signal modulators; wherein the control logic block is to transmit, through the communication interface, respectively signals to the two signal modulators to modulate the two different time-varying currents.

Example 5 may include the apparatus of example 1, wherein the plurality of locations comprise a plurality of passenger seating locations of the vehicle.

Example 6 may include the apparatus of example 1, wherein the control logic block is a first control logic block, and further comprising; a second control logic block, coupled with the first control logic block to receive a command from the location identifier unit to cause the unique instances of the electromagnetic signatures to be generated.

Example 7 may include the apparatus of any examples 1-6, further comprising the IVI system.

Example 8 may include the apparatus of example 7, wherein the service provided to the location is a selected one of a plurality of multi-media services.

Example 9 may include the apparatus of example 7, wherein the apparatus is the vehicle.

Example 10 may include the apparatus of example 9, wherein the vehicle is a computer-assisted or autonomous driving (CA/AD) vehicle.

Example 11 may be a mobile device, comprising: a sensor to detect a time-varying magnetic field; a control logic block coupled with the sensor to identify the time-varying magnetic field detected; and a communications interface coupled with the control logic to transmit a message that indicates the time-varying magnetic field identified.

Example 12 may include the mobile device of example 11, wherein the time-varying magnetic field is associated with a location within a vehicle.

Example 13 may include the mobile device of example 11, wherein the location within the vehicle is a vehicle passenger seat location.

Example 14 may include the mobile device of example 11, wherein to identify, the control logic block is to identify a code associated with the time-varying magnetic field detected.

Example 15 may include the mobile device of example 14, wherein to transmit, the communications interface is to transmit the code identified to an in-vehicle infotainment (IVI) system of a computer-assisted or autonomous driving vehicle.

Example 16 may include the mobile device of example 11, wherein the sensor comprises a Hall effect sensor.

Example 17 may be an apparatus for facilitating audiovisual event in a vehicle, comprising: a first control logic block, disposed in the vehicle to receive, from a mobile device within the vehicle, an indication of an audiovisual event on the mobile device; a second control logic block to identify a location of the mobile device within the vehicle; and a third control logic block, coupled to the first and second control logic blocks, to identify audio or video devices proximate to the identified location of the mobile device and to present audio or video associated with the audiovisual event on the audio or video devices proximate to the identified location of the mobile device.

Example 18 may include the apparatus of example 17, wherein the location of the mobile device is a seating location within the vehicle.

Example 19 may include the apparatus of example 17, wherein the apparatus is the vehicle having the audio or video devices.

Example 20 may include the apparatus of example 17, wherein the third control logic block is further to receive one or more commands from the mobile device, and in response, control the audio or video devices proximate to the identified location of the mobile device, based at least in part on the one or more commands received from the mobile device.

Example 21 may include the apparatus of any one of examples 17-20, wherein the apparatus is an in-vehicle infotainment (IVI) system of the vehicle.

Example 22 may include the apparatus of any one of examples 17-20, wherein the apparatus is the vehicle having at least the first, second and third control logic blocks.

Example 23 may include the apparatus of example 22, wherein the vehicle is a CA/AD vehicle.

Example 24 may be a method for implementing a location identifier system within a vehicle, comprising: receiving, by the location identifier system, a command to cause time-varying currents to be sent; and causing, by the location identifier system, one or more time-varying currents to be sent, respectively, through one or more conductive wire loops at one or more locations within the vehicle.

Example 25 may include the method of example 24, wherein causing one or more time-varying currents to be sent further comprises causing one or more unique instances of electromagnetic signatures at the one or more locations within the vehicle.

Example 26 may include the method of example 25, wherein the instances of electromagnetic signatures are different time-varying magnetic fields.

Example 27 may include the method of example 24, wherein causing one or more time-varying currents to be sent further comprises causing a signal modulator to generate one or more time-varying currents to be sent.

Example 28 may include the method of example 24, wherein receiving a command further comprises receiving a command from an in-vehicle infotainment (IVI) system.

Example 29 may include the method of example 28, wherein the IVI system is an IVI system in the vehicle.

Example 30 may include the method of any one of examples 24-29, wherein the one or more locations within the vehicle further comprise one or more passenger seating locations of the vehicle.

Example 31 may be a method for a mobile device, comprising: determining, by the mobile device, a pattern of a time-varying magnetic field; and transmitting, by the mobile device, an identification of the determined pattern.

Example 32 may include the method of example 31, wherein transmitting an identification of the determined time-varying magnetic field further comprises transmitting the identification to an in-vehicle infotainment (IVI) system.

Example 33 may include the method of example 31, wherein the determined pattern is an electromagnetic signature.

Example 34 may include the method of example 31, wherein the time-varying magnetic field is at a location within a vehicle.

Example 35 may include the method of example 34, wherein the location within the vehicle is a passenger seating location of the vehicle.

Example 36 may include the method of example 31, wherein determining a pattern of a time-varying magnetic field further includes determining the pattern using a Hall Effect sensor within the mobile device.

Example 37 may be a method for implementing an in-vehicle infotainment (IVI) system, comprising: receiving, by the IVI system from a mobile device, a registration request for a vehicle; causing, by the IVI system, a time-varying current to flow in a conductive wire loop proximate to a passenger location within the vehicle; transmitting, by the IVI system, a command to the mobile device to identify a pattern of a time-varying magnetic field; receiving, by the IVI system, the identified pattern from the mobile device; and determining, by the IVI system, based upon the received identified pattern, a location of the mobile device within the vehicle.

Example 38 may include the method of example 37, wherein the pattern of the time-varying magnetic field represents an electromagnetic signature for a location within the vehicle.

Example 39 may include the method of example 37, further comprising providing, by the IVI system, services to the location of the mobile device within the vehicle.

Example 40 may be a non-transitory computer readable medium including code, when executed on a computing system, to cause the computing system to: receive, by a communication interface of the computing system, a command to cause time-varying currents to be sent; and cause, by the communication interface, one or more time-varying currents to be sent, respectively, through one or more conductive wire loops at one or more locations within the vehicle.

Example 41 may include the non-transitory computer readable medium of example 40, wherein cause one or more time-varying currents to be sent further comprises cause one or more unique instances of electromagnetic signatures at the one or more locations within the vehicle.

Example 42 may include the non-transitory computer readable medium of example 41, wherein the instances of electromagnetic signatures are different time-varying magnetic fields.

Example 43 may include the non-transitory computer readable medium of example 40, wherein cause one or more time-varying currents to be sent further comprises cause a signal modulator to generate one or more time-varying currents to be sent.

Example 44 may include the non-transitory computer readable medium of example 40, wherein receive a command further comprises receive a command from an in-vehicle infotainment (IVI) system.

Example 45 may include the non-transitory computer readable medium of example 44, wherein the IVI system is an IVI system in the vehicle.

Example 46 may include the non-transitory computer readable medium of any one of examples 40-45, wherein the one or more locations within the vehicle further comprise one or more passenger seating locations of the vehicle.

Example 47 may be a non-transitory computer readable medium including code, when executed on a mobile device, to cause the mobile device to: determine a pattern of a time-varying magnetic field; and transmit an identification of the determined pattern.

Example 48 may include the non-transitory computer readable medium of example 47, wherein transmit an identification of the determined time-varying magnetic field further comprises transmit the identification to an in-vehicle infotainment (IVI) system.

Example 49 may include the non-transitory computer readable medium of example 47, wherein the determined pattern is an electromagnetic signature.

Example 50 may include the non-transitory computer readable medium of example 47, wherein the time-varying magnetic field is at a location within a vehicle.

Example 51 may include the non-transitory computer readable medium of example 50, wherein the location within the vehicle is a passenger seating location of the vehicle.

Example 52 may include the non-transitory computer readable medium of example 47, wherein determine a pattern of a time-varying magnetic field further includes determine the pattern using a Hall Effect sensor within the mobile device.

Example 53 may be a non-transitory computer readable medium including code, when executed on an in-vehicle infotainment (IVI) system, to cause the IVI system to: receive a registration request for a vehicle; cause a time-varying current to flow in a conductive wire loop proximate to a passenger location within the vehicle; transmit a command to the mobile device to identify a pattern of a time-varying magnetic field; receive the identified pattern from the mobile device; and determine, based upon the received identified pattern, a location of the mobile device within the vehicle.

Example 54 may include the non-transitory computer readable medium of example 53, wherein the pattern of the time-varying magnetic field represents an electromagnetic signature for a location within the vehicle.

Example 55 may include the non-transitory computer readable medium of example 53, further comprising provide services to the location of the mobile device within the vehicle.

Example 56 may be a location identifier apparatus, comprising: means for receiving a command to cause time-varying currents to be sent; and means for causing one or more time-varying currents to be sent, respectively, through one or more conductive wire loops at one or more locations within the vehicle.

Example 57 may include the apparatus of example 56, wherein means for causing one or more time-varying currents to be sent further comprises means for causing one or more unique instances of electromagnetic signatures at the one or more locations within the vehicle.

Example 58 may include the apparatus of example 57, wherein the instances of electromagnetic signatures are different time-varying magnetic fields.

Example 59 may include the apparatus of example 56, wherein means for causing one or more time-varying currents to be sent further comprises means for causing a signal modulator to generate one or more time-varying currents to be sent.

Example 60 may include the apparatus of example 56, wherein means for receiving a command further comprises means for receiving a command from an in-vehicle infotainment (IVI) system.

Example 61 may include the apparatus of example 60, wherein the IVI system is an IVI system in the vehicle.

Example 62 may include the apparatus of any one of examples 24-29, wherein the one or more locations within the vehicle further comprise one or more passenger seating locations of the vehicle.

Example 63 may be a mobile device apparatus, comprising: means for determining, a pattern of a time-varying magnetic field; and means for transmitting an identification of the determined pattern.

Example 64 may include the apparatus of example 63, wherein means for transmitting an identification of the determined time-varying magnetic field further comprises means for transmitting the identification to an in-vehicle infotainment (IVI) system.

Example 65 may include the apparatus of example 63, wherein the determined pattern is an electromagnetic signature.

Example 66 may include the apparatus of example 63, wherein the time-varying magnetic field is at a location within a vehicle.

Example 67 may include the apparatus of example 66, wherein the location within the vehicle is a passenger seating location of the vehicle.

Example 68 may include the apparatus of example 63, wherein determining a pattern of a time-varying magnetic field further includes determining the pattern using a Hall Effect sensor within the mobile device.

Example 69 may be an in-vehicle infotainment (IVI) system, comprising: means for receiving a registration request for a vehicle; means for causing a time-varying current to flow in a conductive wire loop proximate to a passenger location within the vehicle; means for transmitting a command to the mobile device to identify a pattern of a time-varying magnetic field; means for receiving the identified pattern from the mobile device; and means for determining, based upon the received identified pattern, a location of the mobile device within the vehicle.

Example 70 may include the apparatus of example 69, wherein the pattern of the time-varying magnetic field represents an electromagnetic signature for a location within the vehicle.

Example 71 may include the apparatus of example 70, further comprising means for providing services to the location of the mobile device within the vehicle.

1-25. (canceled)

26. An apparatus for servicing a mobile device within a vehicle, comprising:
a plurality of generators disposed at a plurality of locations within the vehicle to respectively generate a plurality of electromagnetic signatures at the plurality of locations; and
a control logic block coupled to the plurality of generators to cause the plurality of generators to respectively generate unique instances of the plurality of electromagnetic signatures at the plurality of locations;
wherein at least one of unique instance of the plurality of electromagnetic signatures is sensed and reported by a mobile device to an in-vehicle infotainment (IVI) system of the vehicle;
wherein the IVI system identifies the mobile device as being disposed in one of the plurality of locations based at least in part on the reporting; and
wherein the IVI system provides services to the location the mobile device is disposed.

27. The apparatus of claim 26, wherein the unique instances of the electromagnetic signatures are different time-varying magnetic fields.

28. The apparatus of claim 27, wherein each of at least two of the plurality of generators comprises a signal modulator and a conductive wire loop, and wherein the control logic block causes the two signal modulators to respectively modulate two different time-varying currents on the two conductive wire loops to cause generation of two of the different time-varying magnetic fields.

29. The apparatus of claim 28, further comprising a communication interface coupled with at least the two signal modulators; wherein the control logic block is to transmit, through the communication interface, respectively signals to the two signal modulators to modulate the two different time-varying currents.

30. The apparatus of claim 26, wherein the plurality of locations comprise a plurality of passenger seating locations of the vehicle.

31. The apparatus of claim 26, wherein the control logic block is a first control logic block, and further comprising;
a second control logic block, coupled with the first control logic block to receive a command from the location identifier unit to cause the unique instances of the electromagnetic signatures to be generated.

32. The apparatus of claim 26, further comprising the IVI system.

33. The apparatus of claim 32, wherein the service provided to the location is a selected one of a plurality of multi-media services.

34. The apparatus of claim 32, wherein the apparatus is the vehicle.

35. A mobile device, comprising:
a sensor to detect a time-varying magnetic field;
a control logic block coupled with the sensor to identify the time-varying magnetic field detected; and
a communications interface coupled with the control logic to transmit a message that indicates the time-varying magnetic field identified.

36. The mobile device of claim 35, wherein the time-varying magnetic field is associated with a location within a vehicle.

37. The mobile device of claim 35, wherein the location within the vehicle is a vehicle passenger seat location.

38. An apparatus for facilitating audiovisual event in a vehicle, comprising:
a first control logic block, disposed in the vehicle to receive, from a mobile device within the vehicle, an indication of an audiovisual event on the mobile device;
a second control logic block to identify a location of the mobile device within the vehicle; and
a third control logic block, coupled to the first and second control logic blocks, to identify audio or video devices proximate to the identified location of the mobile device and to present audio or video associated with the audiovisual event on the audio or video devices proximate to the identified location of the mobile device.

39. The apparatus of claim 38, wherein the location of the mobile device is a seating location within the vehicle.

40. The apparatus of claim 38, wherein the apparatus is the vehicle having the audio or video devices.

41. The apparatus of claim 38, wherein the third control logic block is further to receive one or more commands from the mobile device, and in response, control the audio or video devices proximate to the identified location of the mobile device, based at least in part on the one or more commands received from the mobile device.

42. The apparatus of claim 38, wherein the apparatus is an in-vehicle infotainment (IVI) system of the vehicle.

43. The apparatus of claim 38, wherein the apparatus is the vehicle having at least the first, second and third control logic blocks.

44. The apparatus of claim 44, wherein the vehicle is a computer-assisted or autonomous driving (CA/AD) vehicle.
